(19) United States
(12) Patent Application Publication
(10) Pub. No.: US 2024/0283665 A1
(43) Pub. Date: Aug. 22, 2024

(54) METHODS AND SYSTEMS FOR IMPROVING BLOCKCHAIN TECHNOLOGY

(71) Applicant: NFT BLOCKCHAIN, LLC, Grandville, MI (US)

(72) Inventor: John VanTubergen, Jr., Grand Rapids, MI (US)

(21) Appl. No.: 18/593,066

(22) Filed: Mar. 1, 2024

Related U.S. Application Data
(63) Continuation of application No. PCT/US2022/042511, filed on Sep. 2, 2022.
(60) Provisional application No. 63/240,720, filed on Sep. 3, 2021.

(51) Int. Cl. H04L 9/00; G06Q 20/12; H04L 9/06

(52) U.S. Cl. CPC H04L 9/50; G06Q 20/123; H04L 9/0643; G06Q 2220/10

(57) ABSTRACT

Provided herein are systems and methods for recording a hash of a smart contrast on a blockchain. The system and methods can comprise identifying a smart contract on a blockchain, identifying original terms of the smart contract, and generating a hash of the smart contract.

### CROSS-REFERENCE

This application is a continuation of International Application No. PCT/US2022/042511, filed Sep. 2, 2022, which claims the benefit of U.S. Provisional Application No. 63/240,720 filed Sep. 3, 2021, each of which is hereby incorporated by reference in its entirety.

### BACKGROUND

Blockchains create a secure environment to store information, such as legal documents, ownership transfers, properties, transaction history, etc. Changes made to the stored information can be recorded as a new block in the chain. Modifications and/or additions to any given blockchain requires verification of all the existing blocks of the blockchain. This verification process is resource intensive and requires sub-optimal processing times.

### SUMMARY

In one aspect, disclosed herein are computer-implemented methods of recording a hash of a smart contract on a blockchain comprising: identifying, by a computer, the smart contract on a blockchain network; identifying original terms of the smart contract; and generating a hash of the smart contract on a node, wherein the hash comprises one or more altered terms of the smart contract and wherein the node is not a member of the blockchain. In some instances, the node is a member of a decentralized database that does not comprise the blockchain. In some instances, the decentralized database comprises a plurality of nodes. In some instances, the hash consists of the one or more altered terms. In some instances, the method further comprises, prior to (c), inputting an identification code for each party to the smart contract. In some instances, the method further comprises: d) altering the original terms of the smart contract, the one or more altered terms of the smart contract, or both, and generating a new hash of the smart contract, wherein the new hash comprises one or more further altered terms of the smart contract, and wherein the new hash is recorded on the node. In some cases, the new hash consists of the one or more further altered terms. In some cases, the method further comprises, prior to (d), inputting an identification code for each party to the smart contract. In some cases, (d) is repeated. In some instances, the method further comprises retrieving the hash or the new hash on the node. In some instances, the smart contract is recorded on the node by a unique contract code. In some instances, the hash and the new hash are pooled on the node by the unique contract code. In some instances, (c), (d), or both are performed 10,000 times or more in one second. In some instances, the new hash comprises less storage requirements than the original terms of the smart contract. In some instances, the method further comprises adding a block to the blockchain, wherein adding the block comprises retrieving a hash of one or more previous blocks of the blockchain. In some instances, adding the block comprises retrieving a hash of a previous block. In some cases, the hash is a new hash. In some instances, the hash is stored on a node. In some instances, the node is a member of a decentralized database that does not comprise the blockchain. In some instances, the decentralized database comprises a plurality of nodes.

In another aspect, disclosed herein are computer-implemented systems comprising: at least one processor, a memory, and instructions executable by the at least one processor to create an application for recording a hash of a smart contract on a blockchain, the application comprising: a software module configured to: a) identify a smart contract on a blockchain network; b) identify original terms of the smart contract; and c) generate a hash of the smart contract on anode, wherein the hash comprises one or more altered terms of the smart contract and wherein the node is not a member of the blockchain. In some instances, the node is a member of a decentralized database that does not comprise the blockchain. In some instances, the decentralized database comprises a plurality of nodes. In some instances, the hash consists of the one or more altered terms. In some instances, the software module is further configured to receive an identification code for each party to the smart contract prior to (c). In some cases, the identification code comprises a signature. In some instances, the software module is further configured to: (d) alter the original terms of the smart contract, the one or more altered terms of the smart contract, or both, and generate a new hash of the smart contract, wherein the new hash comprises one or more further altered terms of the smart contract, and wherein the new hash is recorded on the node. In some cases, the new hash consists of the one or more further altered terms. In some cases, the software module is further configured to receive an identification code for each party to the smart contract prior to generating the new hash of the smart contract. In some cases, the software module is further configured to repeat (d). In some cases, the software module generates and assigns a unique contract code to the new hash. In some instances, the software module is further configured to retrieve the hash or the new hash on the node. In some instances, the smart contract is recorded on the node by a unique contract code. In some instances, the hash and the new hash are pooled on the node by the unique contract code. In some cases, the unique contract code comprises a unique contract identification code. In some instances, the software module is configured to perform (c), (d), or both, 10,000 times or more in one second. In some instances, the new hash comprises less storage requirements than the original terms of the smart contract. In some instances, the new hash comprises less storage requirements than the one or more altered terms of the smart contract, redeployment of the smart contract, or a combination thereof. In some instances, the software module is further configured to add a block to the blockchain, wherein adding the block comprises retrieving the new hash of one or more previous blocks of the blockchain. In some instances, adding the block comprises retrieving a hash of a previous block. In some cases, the hash is a new hash. In some instances, the hash is stored on a node. In some instances, the node is a member of a decentralized database that does not comprise the blockchain. In some instances, the decentralized database comprises a plurality of nodes.

In another aspect, disclosed herein are non-transitory computer-readable storage media encoded with a computer program including instructions executable by a processor to create an application for recording a hash of a smart contract on a blockchain, the application comprising: a software module configured to: a) identify a smart contract on a blockchain network; b) identify original terms of the smart contract; and c) generate a hash of the smart contract on anode, wherein the hash comprises one or more altered terms of the smart contract and wherein the node is not a member of the blockchain. In some instances, the node is a member of a decentralized database that does not comprise the blockchain. In some instances, the decentralized database comprises a plurality of nodes. In some instances, the hash consists of the one or more altered terms. In some instances, the software module is further configured to receive an identification code for each party to the smart contract prior to (c). In some instances, the software module is further configured to: (d) alter the original terms of the smart contract, the one or more altered terms of the smart contract, or both, and generate a new hash of the smart contract, wherein the new hash comprises one or more further altered terms of the smart contract, and wherein the new hash is recorded on the node. In some instances, the new hash consists of the one or more further altered terms. In some instances, the software module is further configured to receive an identification code for each party to the smart contract prior to generating the new hash of the smart contract. In some cases, the software module is further configured to repeat (d). In some instances, the software module is further configured to retrieve the hash or the new hash on the node. In some instances, the smart contract is recorded on the node by a unique contract code. In some instances, the hash and the new hash are pooled on the node by the unique contract code. In some instances, the software module is configured to perform (c), (d), or both, 10,000 times or more in one second. In some instances, the new hash comprises less storage requirements than the original terms of the smart contract. In some instances, the software module is further configured to add a block to the blockchain, wherein adding the block comprises retrieving the new hash of one or more previous blocks of the blockchain. In some instances, is a member of a decentralized database that does not comprise the blockchain. In some instances, the decentralized database comprises a plurality of nodes.

In another aspect, disclosed herein are platforms comprising: a processor configured to provide an application for recording a hash of a smart contract on a blockchain, the application comprising: a first software module configured to: a) identify a smart contract on a blockchain network; b) identify original terms of the smart contract; c) generate a unique contract code for the smart contract; and d) generate a hash of the smart contract on a node, wherein the hash comprises one or more altered terms of the smart contract and wherein the node is not a member of the blockchain and wherein the node comprises a server processor; the server processor configured to provide a server application for pooling one or more hashes of one or more smart contracts on the blockchain, the server application comprising: a second software module configured to e) pool the one or more hashes by the unique contract codes for the one or more smart contracts. In some instances, the hash consists of the one or more altered terms. In some instances, the processor is a mobile processor configured to provide a mobile application. In some instances, the software module of the application is further configured to receive an identification code for each party to the smart contract prior to (d). In some cases, the identification code comprises a signature. In some instances, the first software module of the application is further configured to: (f) alter the original terms of the smart contract, the one or more altered terms of the smart contract, or both, and generate a new hash of the smart contract, wherein the new hash comprises one or more further altered terms of the smart contract, and wherein the new hash is recorded on the node. In some instances, the new hash consists of the one or more further altered terms. In some instances, the first software module of the application is further configured to receive an identification code for each party to the smart contract prior to generating the new hash of the smart contract. In some cases, the identification code comprises a signature. In some instances, the first software module of the application may be of a mobile application, which may interact with the server application deployed through an application programmable interface (API). In some cases, the first software module of the application is further configured to repeat (f). In some instances, the second software module of the server application is further configured to retrieve the hash or the new hash on the node. In some instances, the first software module is configured to perform (d), (f), or both, 10,000 times or more in one second. In some instances, the new hash comprises less storage requirements than the original terms of the smart contract. In some instances, the first software module of the application is further configured to add a block to the blockchain, wherein adding the block comprises retrieving the new hash of one or more previous blocks of the blockchain. In some instances, the node is a member of a decentralized database that does not comprise the blockchain. In some instances, the decentralized database comprises a plurality of nodes.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a block diagram for deploying a smart contract in a blockchain;

FIG. 2 shows a non-limiting example of a block diagram for executing a smart contract, in this case with an addendum, in a blockchain;

FIG. 3 shows a non-limiting example of a block diagram for deploying a smart contract in an NFT blockchain;

FIG. 4 shows anon-limiting example of a block diagram for deploying a smart contract, in this case with an addendum, in an NFT blockchain;

FIG. 5 shows anon-limiting example of a block diagram for validating a smart contract, in this case with an addendum, in an NFT blockchain;

FIG. 6 shows a non-limiting example of non-limiting example of a computing device; in this case, a device with one or more processors, memory, storage, and a network interface;

FIG. 7 shows anon-limiting example of a web/mobile application provision system; in this case, a system providing browser-based and/or native mobile user interfaces; and

FIG. 8 shows a non-limiting example of a cloud-based web/mobile application provision system; in this case, a system comprising an elastically load balanced, auto-scaling web server and application server resources as well synchronously replicated databases.

### DETAILED DESCRIPTION

Present blockchain systems require creating anew block over the chain and authenticating existing blocks in the chain each time a change is made. In some instances, a ledger comprising logs of blocks in the blockchain may be compared for consensus prior to adding a block to the blockchain. In some cases, the lack of consensus may result in rejecting the addition of a block to the blockchain. Further, blockchain systems rely on massively replicated execution of smart contract codes during each of these changes. This redeployment and tracking of smart contracts are not scalable, and the efficiency of the transaction decreases while the cost increases with every change and resulting new block added to the blockchain. Adding to this is challenge is the fast-paced transactions that occur in non-fungible token (NFT) marketplaces. Therefore, there is a need for efficient automation that reduces the energy it takes to track and authenticate all of the blocks in the blockchain before creating a new block.

To improve the current inefficient and non-scalable system, an NFT addendum, also known as a smart contract addendum, can be employed. A platform comprising of a decentralized database that can be used to keep track of only the changes, rather than the complete blockchain. Instead of tracking and authenticating one block at a time, the platform easily accesses only the versioning (also referred to as hash) of changes in a new block via the records of the decentralized database for authentication. This introduces energy efficiency to blockchain marketplaces. The addendum not only improves transactions in NFT marketplaces, but also improves other blockchain transactions that are token-based. In some instances, token-based transactions may comprise cryptocurrency (e.g., Bitcoin, Ethereum, Litecoin, Cardano, Chainlink, etc.).

Described herein, in certain embodiments, are computer-implemented methods of recording a hash of a smart contract on a blockchain. The method can comprise one or more of a) identifying, by a computer, the smart contract on a blockchain network; b) identifying original terms of the smart contract; and c) generating a hash of the smart contract on a node. In some instances, the hash comprises one or more altered terms of the smart contract. In some instances, the node is not a member of the blockchain. In some instances, the method further comprises prior to c) inputting an identification code for each party of the smart contract. In some instances, the method further comprises altering the original terms of the smart contract, the one or more altered terms of the smart contract, or both. In some instances, the method further comprises generating a new hash of the smart contract. In some instances, the new hash comprises one or more further altered terms of the smart contract. In some instances, the new hash is recorded on the node. In some instances, the method further comprises prior to d) inputting an identification code for each party to the smart contract. In some instances, d) is repeated. In some instances, the method further comprises retrieving the hash or the new hash on the node. In some instances, the method further comprises adding a block to the blockchain. In some instances, adding the block comprises retrieving the new hash of one or more previous blocks of the blockchain.

Also described herein, in certain embodiments, are computer-implemented systems comprising: at least one processor, a memory, and instructions executable by the at least one processor to create an application for recording a hash of a smart contract on a blockchain. In some instances, the application comprises: a software module configured to perform one or more of: a) identify a smart contract on a blockchain network; b) identify original terms of the smart contract; and c) generate a hash of the smart contract on a node. In some instances, the hash comprises one or more altered terms of the smart contract. In some instances, the node is not a member of the blockchain. In some instances, the software module is further configured to receive an identification code for each party to the smart contract prior to (c). In some instances, the software module is further configured to: (d) alter the original terms of the smart contract, the one or more altered terms of the smart contract, or both. In some instances, the software module is further configured to generate a new hash of the smart contract. In some instances, the new hash comprises one or more further altered terms of the smart contract. In some instances, the new hash is recorded on the node. In some instances, the software module is further configured to receive an identification code for each party to the smart contract prior to generating the new hash of the smart contract. In some instances, the software module is further configured to repeat (d). In some instances, the software module is further configured to retrieve the hash or the new hash on the node. In some instances, the software module is further configured to add a block to the blockchain. In some instances, adding the block comprises retrieving the new hash of one or more previous blocks of the blockchain.

In another aspect, disclosed herein are non-transitory computer-readable storage media encoded with a computer program including instructions executable by a processor to create an application for recording a hash of a smart contract on a blockchain. In some instances, the application comprises: a software module configured to perform one or more of: a) identify a smart contract on a blockchain network; b) identify original terms of the smart contract; and c) generate a hash of the smart contract on a node. In some instances, the hash comprises one or more altered terms of the smart contract. In some instances, the node is not a member of the blockchain. In some instances, the software module is further configured to receive an identification code for each party to the smart contract prior to (c). In some instances, the software module is further configured to: (d) alter the original terms of the smart contract, the one or more altered terms of the smart contract, or both. In some instances, the software module is further configured to generate a new hash of the smart contract. In some instances, the new hash comprises one or more further altered terms of the smart contract. In some instances, the new hash is recorded on the node. In some instances, the software module is further configured to receive an identification code for each party to the smart contract prior to generating the new hash of the smart contract. In some instances, the software module is further configured to repeat (d). In some instances, the software module is further configured to retrieve the hash or the new hash on the node. In some instances, the software module is further configured to add a block to the blockchain. In some instances, adding the block comprises retrieving the new hash of one or more previous blocks of the blockchain.

Also described herein, in certain embodiments, are platforms comprising: a processor configured to provide an application for recording a hash of a smart contract on a blockchain. In some instances, the application comprises: a first software module configured to perform one or more of: a) identify a smart contract on a blockchain network; b) identify original terms of the smart contract; c) generate a unique contract code for the smart contract; and d) generate a hash of the smart contract on a node. In some instances, the hash comprises one or more altered terms of the smart contract. In some instances, the node is not a member of the blockchain. In some instances, the node comprises a server processor. In some instances, the server processor is configured to provide a server application for pooling one or more hashes of one or more smart contracts on the blockchain. In some instances, the server application comprises: a second software module configured to e) pool the one or more hashes by the unique contract codes for the one or more smart contracts. In some instances, the first software module of the application is further configured to receive an identification code for each party to the smart contract prior to (d). In some instances, the first software module of the application is further configured to: (f) alter the original terms of the smart contract, the one or more altered terms of the smart contract, or both. In some instances, the first software module is further configured to generate a new hash of the smart contract. In some instances, the new hash comprises one or more further altered terms of the smart contract. In some instances, the new hash is recorded on the node. In some instances, the first software module of the application is further configured to receive an identification code for each party to the smart contract prior to generating the new hash of the smart contract. In some instances, the first software module of the application is further configured to repeat (f). In some instances, the second software module of the server application is further configured to retrieve the hash or the new hash on the node. In some instances, the first software module of the application is further configured to add a block to the blockchain. In some instances, adding the block comprises retrieving the new hash of one or more previous blocks of the blockchain.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

As used herein, the term “smart contract” or “smart contracts” may generally refer to a computer program or a transaction protocol that comprises one or more executable function for performing a set of actions when triggered according to the terms of the contract. In some cases, the smart contract may be deployed for transactions on a blockchain. In some cases, the smart contract is secured on a decentralized database.

As used herein, the term “decentralized database” or “distributed database” may generally refer to a database that stores data across different physical locations (e.g., nodes) in a decentralized fashion. This scheme transfers authority and trust to a decentralized network (e.g., peer-to-peer (P2P) network) and enables nodes in the network to be continuously and sequentially executed, for example, in order to record transactions on a block in a blockchain. In such cases, cryptography, via hash codes, can be used to secure an authentication of a transaction source and removes a central intermediary.

As used herein, the term “hash” or “hashes” may generally refer to a string of fixed length that is outputted from a hash function. A hash function may generally comprise a function that receives an input of arbitrary length into an output with a fixed length. In some instances, the input may be one or more terms of a transaction or a contract, which may be passed through hash function to generate a hash. In some instances, the hash function may be deterministic, and it may be infeasible to reverse-engineer the input from the hashed output. The act of feeding an input into a hash function may be referred to as “hashing”.

As used herein, the term “non-fungible token”, “non-fungible tokens”, “NFT”, or “NFTs” may generally refer to data stored on a digital ledger, such as a blockchain. The data may be a digital or cryptographic asset that is unique and immutable. Non-limiting examples of an NFT may comprise a unique piece of art, music, a meme, a collectible, a domain name, real estate, etc.

### Smart Contracts

Smart contracts may comprise a program that is stored on a blockchain that may be run or executed when the conditions of the agreement in the contract are met. In some instances, one or more blocks on the blockchain may comprise a smart contract, transactions, or a combination thereof. In some instances, each block needs to be validated prior to updating terms in the smart contract or adding a new smart contract (e.g., adding a new block in the blockchain). The blockchain may comprise a decentralized data structure comprising a decentralized network. In some embodiments, the decentralized network may comprise a plurality of nodes. In some instances, each node in the decentralized network may comprise at least a portion of the blockchain. In some instances, a node may contain a record of the transaction history of a blockchain. In some embodiments, the decentralized network may allow for a trustless environment, since each member (e.g., node) in the network may have their own copy of data. In such embodiment, if each member has their own copy of data in the form of a distributed ledger, an alternation or corruption of one members ledger may be rejected by most or all other members in the decentralized network. In some embodiments, the decentralized network may allow for improved data reconciliation, optimized data distribution, improved security of the network, or any combination thereof. Non-limiting examples of platforms that support blockchains may comprise Ethereum, IBM blockchain, Hyperledger Fabric, Hyperledger Sawtooth, Hedera Hash graph, Corda (R3 Corda), Tezos, EOSIO, Stellar, Quorum, Ripple, NEO, Dragonchain, or OpenChain. Platforms that support blockchains may allow for the transaction of, in some instances, currency (e.g., cryptocurrency), art, documents, real estate, metadata, or any other digital assets. In some cases, an existing standard or protocol, such as ERC-20, ERC-721, ERC-1155, may be used to create tokens (e.g., fungible tokens and non-fungible tokens (NFTs)) that may be used for transactions on platforms, such as those described herein. In some instances, new standards or protocols may be used to create tokens (e.g., NFT-20, NFT-721, NFT-1155) on platforms, such as those described herein. Transaction of digital assets using platforms, such as those described herein, may be performed over one or more platforms comprising one or more processors. In some embodiments, the one or more processors may be a processor configured to provide an application, a server processor configured to provide a server application, or a combination thereof.

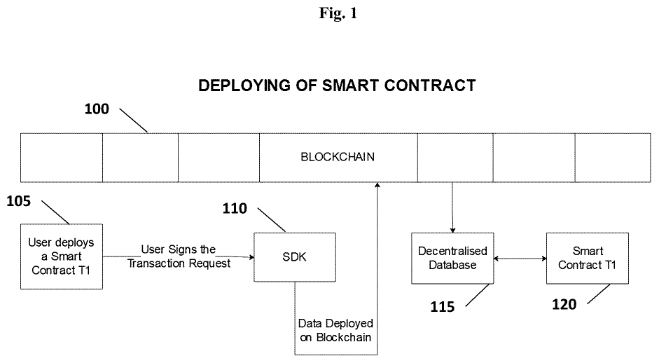

Referring to FIG. 1 is a non-limiting example of a block diagram for deploying a smart contract in a blockchain 100. The blockchain 100 may comprise a decentralized data structure, which may be used for data storage or data retrieval. In some embodiments, the blockchain may be a cryptocurrency blockchain or an NFT blockchain. In some embodiments, the blockchain may be a public blockchain, a private blockchain, a consortium blockchain, a hybrid blockchain, or a combination thereof. In some instances, the blockchain may be a permission-based (e.g., private) system or permission-less (e.g., public) system. In some instances, a password or encryption key may be required to access a blockchain, or one or more blocks in a blockchain. In some cases, the encryption key may be required by a certificate authority (CA).

In some embodiments, a user may deploy a smart contract at T1 105, where T1 is a transaction 1. In some instances, the user may send a transaction to the blockchain to deploy the smart contract. In some cases, the transaction may contain one or more codes of the compiled smart contract. In some examples, the user may not specify the recipient of the smart contract. In some instances, when deploying the smart contract, the user may sign the transaction request, which can be processed using a software development kit (SDK) 110. The SDK 110 may comprise of software tools and programs (e.g., a compiler, a debugger, a software framework, etc.), which in some instances, may be used to deploy smart contracts in blockchain. In some embodiments, there may be a fee associated with deploying a smart contract. The SDK 110 may deploy data related to the smart contract to the blockchain 100.

The blockchain 100 may be coupled to a decentralized database 115, which upon deployment of a smart contract, may retrieve relevant data stored on the decentralized database 115. In some embodiments, the decentralized database 115 may be used to store and access files, websites, applications, or any other data. In some embodiments, the decentralized database 115 may also be referred to as a distributed database. In some embodiments, the decentralized database 115 may store data across different physical locations, such as for example, across a plurality of nodes or servers. This decentralized scheme can transfer authority and/or trust to a decentralized network (e.g., peer-to-peer (P2P) network), as opposed to having a central authority in a centralized database. In some embodiments, the decentralized database 115 may communicate over various transport layers (e.g., transmission control protocol (TCP), uTP, UDT, QUIC, TOR, Bluetooth, etc.). In some embodiments, a decentralized database 115 enables nodes in the network to be continuously executed, sequentially executed, or both in order to record transactions on a block in a blockchain. In some instances, hashes may be employed to secure an authentication of a transaction that occurs in a decentralized database 115. The decentralized database 115 may identify the nodes in the decentralized network with the relevant data related to the deployment of the smart contract. In some instances, the relevant data may comprise of blocks in the blockchain. In some embodiments, every block in the blockchain may be cross-checked, authenticated, or both prior to making changes to the existing blockchain 100.

The decentralized database 115 may then create a file comprising anew smart contract T1 120. In some embodiments, the smart contract T1 120 may be stored across one or more nodes of the network in the decentralized database 115. In some instances, the smart contract T1 120 may be stored using a hash. A hash may be generated using a hash function. The hash function may comprise a function that turns an input of arbitrary length into an output with a fixed length (e.g., 224, 256, 384, 512 bits or characters). The output of a hash function may be deterministic and infeasible to reverse-engineer. Further, generating an output of fixed length may increase security, since any party involved in decrypting a hash would not be able to tell the length of the input. In some cases, the hash may consist of one or more altered terms. In some cases, the hash may be generated upon review of parties involved in the smart contract. In some examples, the hash may be generated upon inputting an identification code, encryption key, password, or any variation thereof for each party involved in the smart contract. In some embodiments, the new smart contract T1 120 may be added to anew block to the existing blockchain 100 and updates to the blockchain are deployed across the relevant nodes in the decentralized database 115. In some instances, the blockchain may comprise a consensus algorithm (e.g., proof of work (PoW) or proof of state (Pos)). In some instances, the PoW consensus algorithm comprises adding a new block to the blockchain. In some examples, adding a new block comprises solving the hash (e.g., mining), which may comprise retrieving data available in the block header (e.g., a version number, a timestamp, the hash used in the previous block, the hash of the Merkle root, the nonce (an arbitrary string of numbers issued in authentication protocols), the target hash, etc.). In some cases, the nonce is appended to the hashed contents of the previous block, which is, in turn, hashed (e.g., passed through a hash function). If the new hash is less than or equal to the target hash, then authorization or access may be granted to add a new block to the blockchain. In some instances, the PoS consensus algorithm comprises attributing mining power to users of a platform to be proportional to tokens held by a user of a platform. In such cases, users are limited to mining a percentage of transactions that is reflective of their ownership stake, which may allow for less energy consumption, since resources are not being allocated towards solving PoW problems.

Smart Contracts with an Addendum

Regardless of the magnitude of change made to a smart contract, every block in the blockchain is typically authenticated prior to adding to or creating a new block with the updated terms. This may be energy inefficient and may occupy a large storage space. As such, an addendum may be used to authenticate only changes to the blockchain stored on the decentralized database. The decentralized database may comprise a plurality of nodes arranged on a decentralized network. In some instances, one or more of the plurality of nodes of the decentralized database may be communicably coupled to one or more nodes of a decentralized network comprising the blockchain. In some embodiments, the decentralized database may record changes and transactions associated with versioning (e.g., hash) for new block generation, and unlimited changes may be made within the chain without a lengthy authentication and information retrieval process. This may increase energy-efficiency, since energy consumption for transactions may be reduced, the speed for updates to the blockchain may be increased, or both. For instance, in NFT blockchains, NFTs may be made in the hundreds, thousands, or millions over an NFT marketplace using an NFT Wallet. In some embodiments, the incorporation to the addendum to the blockchain may allow for about 1000, about 3000, about 5000, about 8000, about 10,000, about 12,000, about 15,000, about 20,000, about 30,000, about 40,000, or about 50,000 transactions per second for millions of cryptocurrencies (e.g., Ethereum, Cardano, Bitcoin, Maker, Tether, Polkadot, Dodgecoin, USD Coin, Solana, XRP, Binance Coin, Terra, Litecoin, Chainlink, EOS, PancakeSwap, Basic Attention Token, etc.) or NFT trades to be done in a marketplace. In some embodiments, the incorporation to the addendum to the blockchain may allow for more than 1000, more than 3000, more than 5000, more than 8000, more than 10,000, more than 12,000, more than 15,000, more than 20,000, more than 30,000, more than 40,000, or more than 50,000 transactions per second for millions of cryptocurrencies or NFT trades to be done in a marketplace.

The use of an addendum may comprise creating the unique ID (e.g., block's DNA) when a new block is added in the blockchain or when one or more terms of a smart contract in a block of the blockchain are altered (e.g., new update is made). In such embodiments, an addendum (e.g., a hash) of a smart contract may be recorded on a blockchain by first identifying the smart contract on the blockchain network and identifying the original terms of the smart contract. In some instances, prior to any change to the smart contract, one or more parties involved in the contract may be required to input an identification code, encryption key, password, or any variation thereof that provides authentication or authorization. In some cases, a software module may be configured to receive the authentication or authorization. An addendum (or hash) of the smart contract may then be generated on a node on a decentralized database. In some instances, an addendum created on a node of the decentralized database may comprise a unique contract code (e.g., unique DNA ID). The addendum may comprise one or more altered terms of the smart contract. In some instances, the addendum consists of one or more altered terms on the smart contract. In some instances, another addendum may be created according to further altered terms of a smart contract. The further altered terms may be alteration of the original terms of the smart contract or any prior altered terms of the smart contract. In some cases, a new addendum (or hash) may be created comprising one or more further altered terms of the smart contract. In some examples, the new addendum may be recorded on a node of the decentralized database. In some cases, the new addendum consists of one or more further altered terms. In some examples, the new addendum may require less storage requirement than the original terms of the smart contract. This may make the system more energy efficient and increase the speed of transactions on blockchain platforms. In some examples, existing addendum(s) and new addendum(s) may be pooled by a unique contract code. In some instances, prior to any change to the new smart contract, one or more parties involved in the contract may be required to input an identification code, encryption key, password, or any variation thereof that provides authentication or authorization. The processed for altering smart contracts as described herein may be repeated (e.g., new addendums may be created). In some embodiments, transactions associated with altering the smart contracts such as those described herein may be performed up to 5,000, 8,000, 9,000, 10,000, 11,000, 12,000, 15,000, or 20,000 times per second. In some embodiments, transactions associated with altering the smart contracts such as those described herein may be performed more than 5,000, 8,000, 9,000, 10,000, 11,000, 12,000, 15,000, or 20,000 times per second. In some instances, the transactions may be performed between about 5,000 to 20,000, 8,000 to 15,000, 8,000 to 12,000, 10,000 to 15,000, 10,000 to 20,000 times per second. In some instances, the addendum(s) of smart contracts on one or more blocks on the blockchain may need to be retrieved, such as when adding a new block to the blockchain or invoking a smart contract. In such instances, such when there's a change that creates a new block, instead of tracking back every block, the system may only check changes through the block's DNA ID stored in the decentralized database. This may allow the system to be more efficient since every block on the blockchain may not have to be validated.

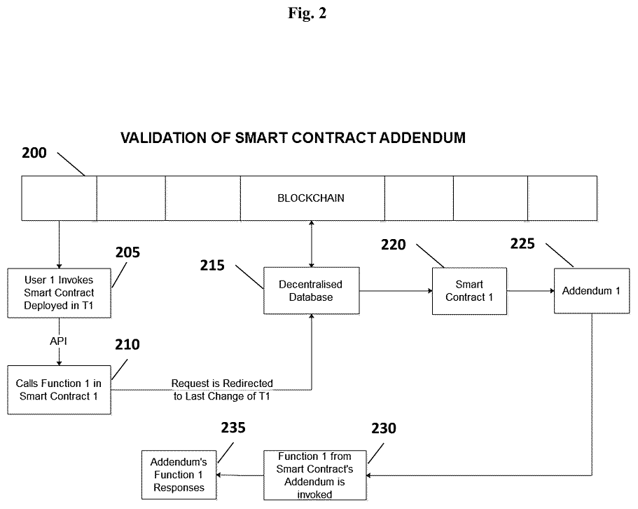

Referring to FIG. 2, is a non-limiting example of a block diagram for invoking a smart contract in a blockchain 100, in this case with an addendum. An addendum in a blockchain may comprise changes or updates to a previously deployed smart contract in a block of the blockchain. The changes or updates may be agreed upon by all parties involved in the contract. Once a smart contract is deployed on a blockchain 200, the smart contract may be invoked, as illustrated in FIG. 2, where user 1 invokes smart contract deployed in T1 205. The smart contract may be invoked using a script comprising a hash for generating a unique identifier of the smart contract (e.g., a unique contract code or DNA ID). In some embodiments, a user may query details of a smart contract prior to invoking the smart contract may query contract details. In some embodiments, invoking a smart contract may require one or more signatures of the parties involved. In some instances, one of the one or more signatures is of the transaction initiator. In some embodiments, invoking a smart contract may require one or more identification codes, passwords, encryption keys, or variations thereof to be inputted by one or more parties involved. In some cases, the signature(s) may be required to support a fee associated with invoking the smart contract.

When a user invokes a smart contract, an application programmable interface (API) may be used to call a function in that smart contract. Referring to FIG. 2, where user 1 invokes smart contract deployed in T1 205, an API is used to call function 1 in smart contract 1 210. The functions in smart contracts may comprise of programs stored in blocks of the blockchain that are executed when predetermined conditions are met. The request may be redirected to a decentralized database 215, which stores data related to change(s) of T1, including the last change of T1. The decentralized database 215 may comprise one or mode nodes arranged on a decentralized network. The decentralized database 215 may be coupled to the blockchain 200.

The decentralized database 215 can access the smart contract 1 220, which in this instances, is already deployed. In a blockchain with an addendum, the decentralized database 215 may identify the smart contract 1 220, and further access the smart contract's addendum, in this case, addendum 1 225. In such instances, function 1 from the smart contract's addendum is invoked 230, as opposed to function 1 in smart contract 1. Function 1 from the smart contract's addendum may be executed to produce the addendum's function 1 responses 235, which can invoke the smart contract deployed in T1. Accessing the smart contract's addendum on a node in the decentralized database, as opposed to validating every block on the blockchain, may allow the system to be more energy-efficiency, increase the speed of transactions on the blockchain, and require less storage.

The processes occurring on a system comprising a blockchain and an addendum, such as those described herein, may be supported by a platform comprising one or more processors. In some instances, the one or more processors may be configured to provide an application. In some embodiments, the one or more processors may comprise a mobile processor, a server processor, or a combination thereof. In some instances, the mobile processor may be configured to provide a mobile application. The mobile application may be used for performing transaction on a blockchain (e.g., Robinhood, Gemini, Coinbase, Etoro, SoFi, CashApp, etc.), recording a hash or an addendum of a smart contract on a blockchain, or developing digital assets to be deployed on a blockchain (Ethereum, Coinbase Wallet, Metamask Wallet, Trust Wallet, SketchAR, S!NG, OpenSea, Nifty Gateway etc.). In some embodiments, the application may comprise a software module, which may identify a smart contract on a blockchain network and identify original terms of the smart contract. A unique contract code or DNA ID may be generated for the smart contract, as well as an addendum or hash of the smart contract. In some instances, the addendum may comprise one or more altered terms of the smart contract. The addendum may be created on a decentralized database, in some instances, specifically on a node of the decentralized database comprising a server processor. The server processor may be configured to provide a server application comprising a software module for pooling one or more addendums of smart contracts on the blockchain.

### NFT Blockchain

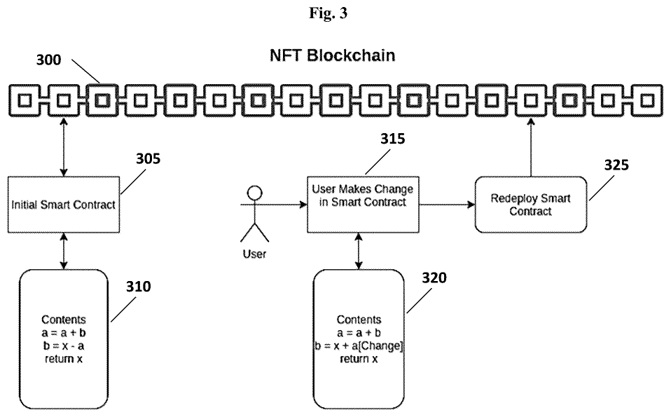

In the NFT marketplace, blockchains may be used to record transactions. NFTs may comprise of unique and immutable digital assets, such as, by way of non-limiting example, a piece of art, music, a meme, a collectible, a domain name, real estate, etc. In some instances, NFTs may be created using ERC-721, which allows for immutable and transparent ownership of an NFT. In some cases, ERC-721 may be used for tracking ownership of a unique NFT. In some instances, NFTs may be created using ERC-1155, which supports the tokenization for both NFTs and fungible tokens. In some cases, it may be efficient to use ERC-1155 for transferring a batch of tokens. In some cases, gas fees may be lower using ERC-1155. Referring to FIG. 3, is a non-limiting example of a block diagram for deploying a smart contract in an NFT blockchain. A smart contract may be deployed in an NFT blockchain 300, similar to the procedure in a non-NFT blockchain, as described herein. In the example in FIG. 3, an initial smart contract 305 may contain contents “a=a+b, b=x−a, return x” 310. When a user makes a change in the smart contract 315, contents may be updated, for example, such that “a=a+b, b=x+a [Change], return x” 320. The smart contract with updated content may then be redeployed 325 on the blockchain. The updates to the smart contract may be added as a new block in the blockchain, where each of the blocks in the blockchain may be authenticated prior.

NFT Blockchain with an Addendum

A bottleneck for NFT blockchains is the transactions that can be done per second. That is, the redeployment and tracking of smart contracts every time there is a small or major change may not be scalable, and with every change and resulting new block the efficiency of the transaction can decrease while the cost increases. This may be problematic for NFT-focused platforms (e.g., an NFT blockchain) where the changes to contracts that take up time are ownership transfers and other minor changes, while most properties in the contract may remain the same. Further, the energy it takes to track and authenticate all of the blocks before creating a new block can be especially problematic for NFT marketplaces, where trade is fast-paced. An NFT addendum may be used in NFT blockchains, where an ecosystem comprising a decentralized database can be used to keep track of only the changes to blocks in a blockchain. The changes can be recorded on the decentralized database, as opposed to the complete blockchain themselves. This can introduce energy efficiency to current blockchain marketplaces, since deploying an NFT addendum can minimize the re-work when updating or re-deploying existing smart contracts. NFT addendums can allow for efficient automation of transactions in NFT marketplaces.

The use of NFT addendums can comprise creating a unique ID (e.g., NFT DNA) at the time of the NFT registry in the continuous blockchain. Each new change to a smart contract in the NFT blockchain can create a new block and instead of tracking every block in the blockchain, the NFT addendum can check the changes through NFT DNA ID through the decentralized database. Each NFT can have a unique ID in the blockchain (NFT DNA ID) and all those updates can be recorded into a decentralized database. The use of NFT DNA IDs may create an energy-efficient way to create new blocks with updated information and authenticate blocks containing new information through recorded changes in the decentralized database, since traditional cross-authentication of every block may not be necessary.

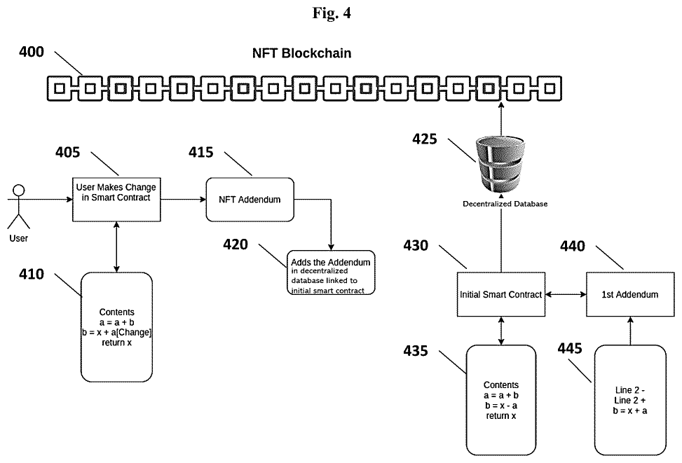

Referring to FIG. 4, is a non-limiting example of a block diagram for deploying a smart contract, in this case with an addendum, in an NFT blockchain. In such embodiment, a user makes a change in smart contract 405 in an NFT blockchain 400. The content of the contract may be changed, similarly to the example illustrated in FIG. 3, such that the contents are updated to be “a=a+b, b=x+a [Change], return x” 410, from “a=a+b, b=x−a, return x”. An NFT addendum 415 may be created comprising these changes, to reflect that the second line in the content has been updated. Once an NFT addendum 415 is created, it may be added to a decentralized database linked to the initial contract 420.

The decentralized database that the NFT addendum 415 is added to may be a decentralized database 425 communicably coupled to the NFT blockchain 400. Data regarding the initial smart contract 430 may be stored on the decentralized database 425. In the example illustrated in FIG. 4, the initial smart contract 430 comprises contents “a=a+b, b=x−a, return x” 435. The initial smart contract 430 may be linked to a 1st addendum 440 in the decentralized database 425, which was created by the user through the content change illustrated in FIG. 4 and described herein. The 1st addendum 440 may only comprise updates to the changes of the initial smart contract 430, such as “Line 2−, Line 2+, b=x+a” 445. Thus, less storage may be required since only changes to the initial smart contract are stored.

The NFT addendum may generally be a new file with changes of transactions, which may be stored on a decentralized database. In some embodiments, the new change may be published. In some instances, no change may be made to the contract once published. In some cases, the published contract may comprise a unique the NFT DNA ID, which may also not be changed. In such cases, since the NFT DNA ID remains the same in reference to the initial contract, users may not have to update their existing codebase. In some cases, once an addendum is created, the corresponding NFT DNA ID may never be changed. In some embodiments, metadata related to the NFTs and the addendums may be stored as files (e.g., JSON, CSV, XML, TXT, etc.). In some instances, the storage files may enable publishing of metadata/URI files on the decentralized database. In such instances, whenever a user proposes a change to the contract, the system may create a new file of the URI and update the NFTs. The system may further keep a record the changes and public transaction on the blockchain. Using a decentralized database for storing information related to the NFTs provides a versioning feature that can be used to implement addenda and maintain the change history of an NFT (e.g., its corresponding transaction(s)). In some cases, a change may be publicly accessibly such that a member of the general public may see earlier versions of the NFTs. In some cases, a change may be privately accessible through an encryption key or password in order to view earlier versions of the NFTs. Incorporation of addendums into the blockchain may allow for less storage on nodes and reduced time for each transaction for a given block. In some embodiments, the fetching speed may depend upon the node's response time. The fetching speed may be based on the transactions per second (TPS), which is a unit to calculate the total number of transactions that can be validated/entered in a blockchain each second. In some instances, the fetching speed may average about 600 TPS, about 800 TPS, about 1000 TPS, about 1200 TPS, or about 1400 TPS. In some instances, the fetching speed may average more than 600 TPS, more than 800 TPS, more than 1000 TPS, more than 1200 TPS, or more than 1400 TPS. In some instances, the fetching speed may average in a range of about 500 to 1500 TPS, about 500 to 1200 TPS, about 700 to 1500 TPS, or about 900 to 1100 TPS.

In some embodiments, the fees associated with deploying smart contracts on the blockchain may be reduced compared to conventional methods due to fixed gas fees and proof of stake (PoS) consensus. Gas fee may generally comprise the fee(s) associated with conducting a transaction. In some embodiments, the fee(s) may be paid using tokens of the governing platform (e.g., Ethereum, Bitcoin, Chainlink, etc.). The PoS consensus may generally comprise an algorithm or protocol that may select validators in proportion to their quantity of holdings, as opposed to proof of work (PoW). In some instances, the deployment fee in an NFT blockchain with an addendum may be no more than $5, $10, $15, $20, $25, $30, $35, $40, $45, $50, $60, $70, $80, $90 or $100. In some instances, the deployment fee in an NFT blockchain with an addendum may be in the range of $1 to $100, $1 to $50, $1 to $20, or $1 to $10.

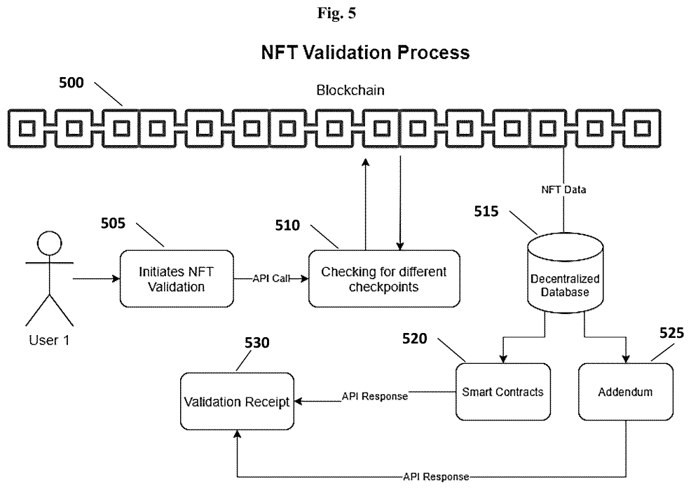

Once a smart contract is deployed on an NFT blockchain with an addendum, the validation process of an NFT may also be done efficiently. Referring to FIG. 5 is a non-limiting example of a block diagram for validating a smart contract in an NFT blockchain, in this case with an addendum. A user 1 may initiate an NFT validation 505 on an NFT blockchain 500. In some instances, the validation is done in order to add a new block to the blockchain. The initiation of an NFT validation 505 may trigger an API call that checks for different checkpoints 510 on the NFT blockchain 500. The relevant NFT data may be identified, and rather than collecting all the relevant transaction data in all the blocks in the blockchain (e.g., hashes), a decentralized database 515 is used to check only the relevant smart contracts 520 and the addendum(s) 525 made to the smart contracts 520. Once both the smart contracts 520 and the addendum(s) 525 are checked, an API response is triggered and compiled into a validation receipt 530. If there is a consensus and no issues are flagged, the NFT may be validated. In some cases, a new block may be added to the blockchain comprising a new smart contract. In some cases, an addendum may be created comprising updates to existing terms of the smart contract.

### Computing System

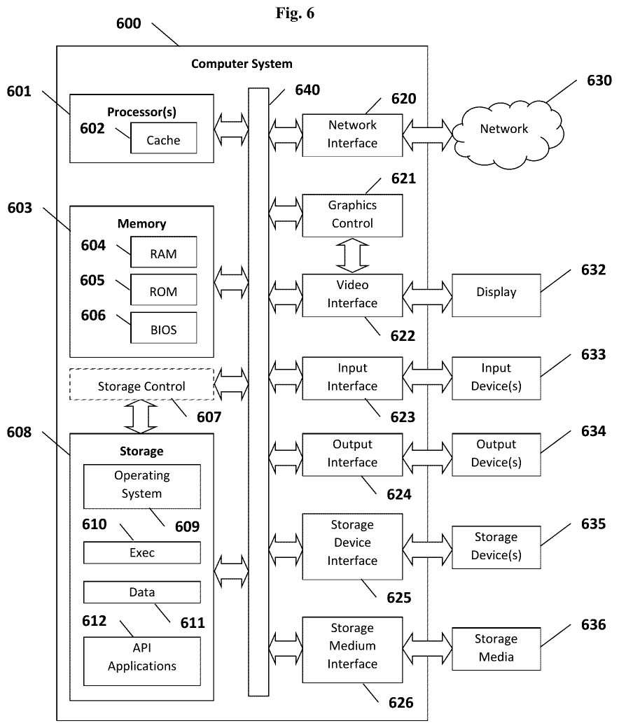

Referring to FIG. 6, a block diagram is shown depicting an exemplary machine that includes a computer system 600 (e.g., a processing or computing system) within which a set of instructions can execute for causing a device to perform or execute any one or more of the aspects and/or methodologies for static code scheduling of the present disclosure. The components in FIG. 6 are examples only and do not limit the scope of use or functionality of any hardware, software, embedded logic component, or a combination of two or more such components implementing particular embodiments.

Computer system 600 may include one or more processors 601, a memory 603, and a storage 608 that communicate with each other, and with other components, via a bus 640. The bus 640 may also link a display 632, one or more input devices 633 (which may, for example, include a keypad, a keyboard, a mouse, a stylus, etc.), one or more output devices 634, one or more storage devices 635, and various tangible storage media 636. All of these elements may interface directly or via one or more interfaces or adaptors to the bus 640. For instance, the various tangible storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 600 includes one or more processor(s) 601 (e.g., central processing units (CPUs), general purpose graphics processing units (GPGPUs), or quantum processing units (QPUs)) that carry out functions. Processor(s) 601 optionally contains a cache memory unit 602 for temporary local storage of instructions, data, or computer addresses. Processor(s) 601 are configured to assist in execution of computer readable instructions. Computer system 600 may provide functionality for the components depicted in FIG. 6 as a result of the processor(s) 601 executing non-transitory, processor-executable instructions embodied in one or more tangible computer-readable storage media, such as memory 603, storage 608, storage devices 635, and/or storage medium 636. The computer-readable media may store software that implements particular embodiments, and processor(s) 601 may execute the software. Memory 603 may read the software from one or more other computer-readable media (such as mass storage device(s) 635, 636) or from one or more other sources through a suitable interface, such as network interface 620. The software may cause processor(s) 601 to carry out one or more processes or one or more steps of one or more processes described or illustrated herein. Carrying out such processes or steps may include defining data structures stored in memory 603 and modifying the data structures as directed by the software.

The memory 603 may include various components (e.g., machine readable media) including, but not limited to, a random access memory component (e.g., RAM 604) (e.g., static RAM (SRAM), dynamic RAM (DRAM), ferroelectric random access memory (FRAM), phase-change random access memory (PRAM), etc.), a read-only memory component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable tangible computer-readable media described below. In one example, a basic input/output system 606 (BIOS), including basic routines that help to transfer information between elements within computer system 600, such as during start-up, may be stored in the memory 603.

Fixed storage 608 is connected bidirectionally to processor(s) 601, optionally through storage control unit 607. Fixed storage 608 provides additional data storage capacity and may also include any suitable tangible computer-readable media described herein. Storage 608 may be used to store operating system 609, executable(s) 610, data 611, applications 612 (application programs), and the like. Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide non-volatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, specifically mobile devices and enterprise systems, distributed computing systems, cloud storage systems, cloud computing systems, and the like, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 630, may employ a wired and/or a wireless mode of communication. In general, any network topology may be used.

Information and data can be displayed through a display 632. Examples of a display 632 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 632, computer system 600 may include one or more other peripheral output devices 634 including, but not limited to, an audio speaker, a printer, a storage device, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

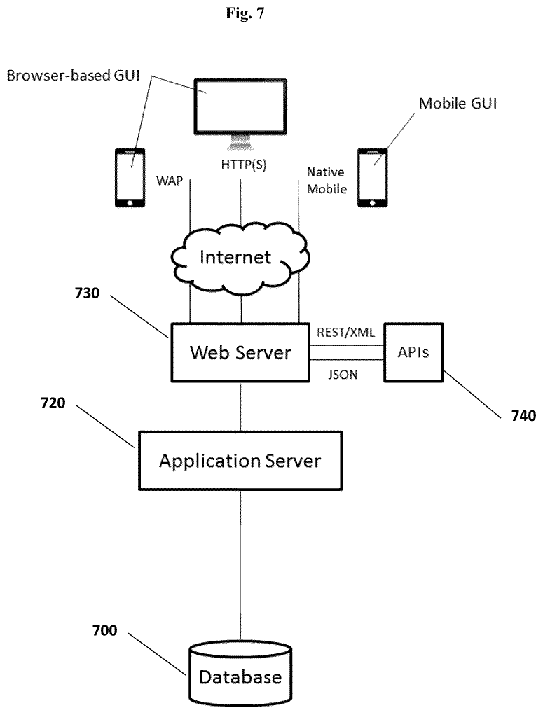

Referring to FIG. 7, in a particular embodiment, an application provision system comprises one or more databases 700. In this embodiment, the application provision system further comprises one or more application severs 720 (such as Java servers, .NET servers, PHP servers, and the like) and one or more web servers 730 (such as Apache, IIS, GWS and the like). The web server(s) optionally expose one or more web services via app application programming interfaces (APIs) 740. Via a network, such as the Internet, the system provides browser-based and/or mobile native user interfaces.

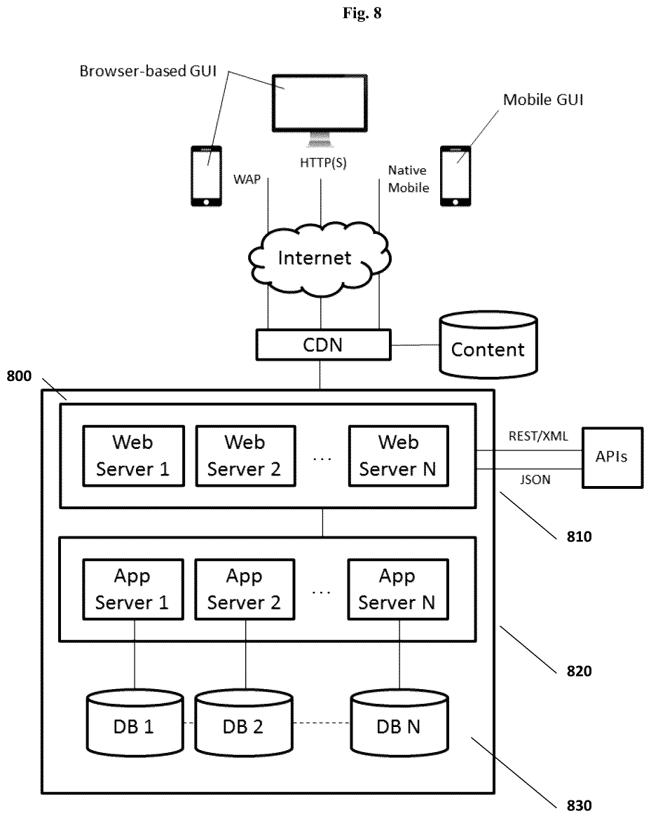

Referring to FIG. 8, in a particular embodiment, an application provision system alternatively has a distributed, cloud-based architecture 800 and comprises elastically load balanced, auto-scaling web server resources 810 and application server resources 820 as well synchronously replicated databases 830.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of blockchain information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of the software applications, systems, and methods described herein and are not meant to be limiting in any way.

### Example 1—Storage Reduction Using Blockchain with an Addendum

Smart contracts, each about 100 Kb, are deployed on an NFT blockchain comprising an addendum according to the general scheme illustrated in FIG. 4. Ten smart contracts are deployed, which is collectively about 1000 Kb. Updates to the terms of each of the smart contracts are made, which results in each being about 124 Kb, which collectively takes up 1240 Kb (1.18 Mb). The total storage needed for the new smart contracts is approximately 2240 Kb (2.17 Mb).

However, instead of storing the entire updated contract, an addendum is created on a node of a decentralized database. The addendum comprises only the changes to the smart contract. Therefore, the addendum is only the 240 Kb of updated code in the updated smart contract, and not the 1000 Kb of the previously deployed smart contract. The addendums are recorded (or stored) on one or more nodes of the decentralized database. The addendum is accompanied by a unique contract code linked to the original smart contract that is used to identify it. The use of an addendum in the NFT blockchain results in a storage reduction of approximately 40% to 50%.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

1. A computer-implemented method of recording a hash of a smart contract on a blockchain comprising:
a) identifying, by a computer, the smart contract on a blockchain network;
b) identifying original terms of the smart contract; and
c) generating a hash of the smart contract on a node, wherein the hash comprises one or more altered terms of the smart contract and wherein the node is not a member of the blockchain.

2. The method of claim 1, wherein the hash consists of the one or more altered terms.

3. The method of claim 1, wherein the method further comprises, prior to (c), inputting an identification code for each party to the smart contract.

4. The method of claim 1, wherein the method further comprises:
d) altering the original terms of the smart contract, the one or more altered terms of the smart contract, or both, and generating a new hash of the smart contract, wherein the new hash comprises one or more further altered terms of the smart contract, and wherein the new hash is recorded on the node.

5. The method of claim 4, wherein the new hash consists of the one or more further altered terms.

6. The method of claim 4, wherein the method further comprises, prior to (d), inputting an identification code for each party to the smart contract.

7. The method of claim 4, wherein (d) is repeated.

8. The method of claim 4, wherein the method further comprises retrieving the hash or the new hash on the node.

9. The method of claim 4, wherein the smart contract is recorded on the node by a unique contract code.

10. The method of claim 9, wherein the hash and the new hash are pooled on the node by the unique contract code.

11. The method of claim 4, wherein (c), (d), or both are performed 10,000 times or more in one second.

12. The method of claim 4, wherein the new hash comprises less storage requirements than the original terms of the smart contract.

13. The method ofany claim 4, wherein the method further comprises adding a block to the blockchain, wherein adding the block comprises retrieving the new hash of one or more previous blocks of the blockchain.

14. The method ofany claim 1, wherein the node is a member of a decentralized database that does not comprise the blockchain.

15.-42. (canceled)

43. A platform comprising:
a processor configured to provide an application for recording a hash of a smart contract on a blockchain, the application comprising:
a first software module configured to:
a. identify a smart contract on a blockchain network;
b. identify original terms of the smart contract;
c. generate a unique contract code for the smart contract; and
d. generate a hash of the smart contract on a node, wherein the hash comprises one or more altered terms of the smart contract and wherein the node does not comprise a member of the blockchain and wherein the node comprises a server processor;
the server processor configured to provide a server application for pooling one or more hashes of one or more smart contracts on the blockchain, the server application comprising:
a second software module configured to
e. pool the one or more hashes by the unique contract codes for the one or more smart contracts.

44. The platform of claim 43, wherein the hash consists of the one or more altered terms.

45. The platform of claim 43, wherein the first software module of the application is further configured to receive an identification code for each party to the smart contract prior to (d).

46.-54. (canceled)

55. The method of claim 1, wherein the method is initiated by a single user.

56. The method of claim 4, wherein the original terms of the smart contract is altered by a single user.

57. The method of claim 13, wherein the block to the blockchain is added by a single user.
